(19) United States
(12) Patent Application Publication
(10) Pub. No.: US 2015/0225275 A1
(43) Pub. Date: Aug. 13, 2015

(54) GLASS COMPONENT FABRICATION METHOD

(71) Applicant: Konica Minolta, Inc., Tokyo (JP)

(72) Inventor: Toshiya Tomisaka, Tokyo (JP)

(73) Assignee: KONICA MINOLTA, INC., TOKYO (JP)

(21) Appl. No.: 14/431,094

(22) PCT Filed: Aug. 21, 2013
(86) PCT No.: PCT/JP2013/072300

§ 371 Date: Mar. 25, 2015

(30) Foreign Application Priority Data
Sep. 25, 2012 (JP) 2012-210721

(51) Int. Cl. C03B 11/08

(52) U.S. Cl. CPC C03B 11/082; C03B 2215/412

(57) ABSTRACT

A method for fabricating a glass component including a component main body with a primary face as a molding face and a standing wall which is molded to extend from the peripheral part of the primary face includes a drop step, a press step, and a working step. In the press step, by the filling with the molten glass, an inner wall face of the standing wall and the primary face are molded with the upper die, an outer wall face of the standing wall and a rear face of the primary face are molded with the lower die, the working part is set in the rear face side of the primary face, and in the working step, the working part is ground or polished from the rear face side of the primary face.

### TECHNICAL FIELD

The present invention relates to a method for fabricating a glass component, and more particularly relates to a method for fabricating, for example, a cover glass provided on an image display surface in a smartphone (high-functionality cellular phone).

### BACKGROUND ART

Digital appliances having an image display function (e.g., cellular telephones, smartphones, and mobile computers) are typically provided with a cover glass for protecting their image display surface. While common cover glasses are shaped like flat sheets, there is demand also for cover glasses with three-dimensional shapes (see, e.g. Patent Document 1) out of design considerations. On the other hand, use of glass-made cover members has been studied not only as cover glasses for protecting image display surfaces but also as exterior covers for digital appliances (see, e.g. Patent Document 2).

Patent Document 1 discloses a cover glass for a flat panel display, along with a method for fabrication thereof, comprising a display portion located at the front face of an image display portion and extending in a flat plane, a bent portion bent from each side of the display portion in its width direction, and a skirt portion (upright wall) extending from the bent portion. This cover glass is fabricated by first heating an entire glass sheet and then locally heating and thereby bending that part of it which is to become the bent portion.

Patent Document 2 discloses a method for fabrication of a glass product having a flat portion (main face) extending in a flat plane, a bent portion bent from an end part of it, and a side wall (upright wall) extending from the bent portion. This glass product is molded by a method called gradual-pressurization molding. The die (lower mold) used has a bottom wall, a side wall contiguous with the bottom wall, a plurality of end walls, and a transitory region shaped orderly so as to widen outward from the side wall to the end walls, and is so formed that the inner dimension gradually decreases from the end walls to the transitory region. A glass sheet is placed so as to make contact only with the edge of the die, then the glass sheet is heated until it has a viscosity in the range of 10⁷ to 10¹³ poises, then a plunger (upper mold) is lowered, and the glass sheet is molded under pressure between the die and the plunger; thus the glass product is molded.

### LIST OF CITATIONS

### Patent Literature

### Patent Document 1: JP-A-2012-101975

### Patent Document 2: JP-A-2012-509842

### SUMMARY OF THE INVENTION

### Technical Problem

With the method disclosed in Patent Document 1, it is difficult to give the bent portion a small radius of curvature. For example, in the case of a cover glass for a portable appliance, a large radius of curvature in the bent portion makes it impossible to secure a large display surface, disallowing effective use up to a circumferential part. Also, it is difficult to form the upright wall around the entire circumference of the flat portion. With the method disclosed in Patent Document 2, forming the bent portion and the upright wall from the glass sheet around the entire circumference brings the disadvantage that wrinkles and cracks are more likely to develop in corner parts.

Devised against the background discussed above, the present invention aims to provide, as a method for fabricating a glass component having an upright wall extending from a main face (e.g., a glass-made cover member shaped like a box or having a U-shaped sectional shape), one that makes it easy to fabricate a glass component with a small radius of curvature at the boundary between the inner wall face of the upright wall and the main face and with satisfactory exterior appearance quality.

### Means for Solving the Problem

To achieve the above aim, according to one aspect of the present invention, a method for fabricating a glass component including

a component main body having a main face as a molded face and

an upright wall formed to extend from a peripheral part of the component main body

includes:

a dropping process in which molten glass is dropped onto a lower mold;

a pressing process in which the molten glass on the lower mold is pressed by an upper mold so that the space enclosed by the lower and upper molds is filled by the molten glass and thereby a preform is formed which includes a molding main body corresponding to the glass component and a to-be-worked portion unnecessary for the glass component; and

a working process in which the to-be-worked portion is removed from the preform by grinding or polishing. Here,

in the pressing process, as a result of filling with the molten glass, the inner wall face of the upright wall and the main face are molded by the upper mold, the outer wall face of the upright wall and the reverse face of the main face are molded by the lower mold, and the to-be-worked portion is left on the reverse face side of the main face, and

in the working process, the to-be-worked portion is ground or polished from the reverse face side of the main face.

According to another aspect of the present invention, a method of fabricating a glass component including

a component main body having a main face as a molded face and

an upright wall formed to extend from a peripheral part of the component main body includes:

a dropping process in which molten glass is dropped onto a lower mold;

a pressing process in which the molten glass on the lower mold is, while being surrounded by an outer mold, pressed by an upper mold so that the space enclosed by the lower, upper, and outer molds is filled by the molten glass and thereby a preform is formed which includes a molding main body corresponding to the glass component and a to-be-worked portion unnecessary for the glass component; and

a working process in which the to-be-worked portion is removed from the preform by grinding or polishing. Here,

in the pressing process, as a result of filling with the molten glass, the inner wall face of the upright wall and the main face are molded by the upper mold, the outer wall face of the upright wall is molded by the outer mold, the reverse face of the main face is molded by the lower mold, and the to-be-worked portion is left on the reverse face side of the main face, and

in the working process, the to-be-worked portion is ground or polished from the reverse face side of the main face.

### Advantageous Effects of the Invention

Through the filling with the molten glass in the pressing process, the inner wall face of the upright wall and the main face are molded by the upper mold, and thus no bending is necessary. Moreover, the to-be-worked portion removed by grinding or polishing in the working process is located on the reverse face side of the main face in the pressing process, and thus not only the working process but also molding in the pressing process can be performed satisfactorily and easily. Thus, according to the present invention, it is easy to fabricate a glass component (e.g., a glass-made cover member shaped like a box or having a U-shaped sectional shape) with a small radius of curvature at the boundary between the inner wall face of the upright wall and the main face and with satisfactory exterior appearance quality.

### BRIEF DESCRIPTION OF DRAWINGS

FIG. 1 comprises diagrams showing a procedure for the fabrication of a cover glass according to a first embodiment of the present invention;

FIG. 2 comprises plan views showing other practical examples of a preform and a cover glass according to the first embodiment;

FIG. 3 comprises diagrams showing a procedure for the fabrication of a cover glass according to a second embodiment of the present invention;

FIG. 4 comprises plan views showing other practical examples of a preform and a cover glass according to the second embodiment;

FIG. 5 comprises plan views showing other practical examples of a preform and a cover glass according to the third embodiment;

FIG. 6 comprises plan views showing other practical examples of a preform and a cover glass according to the fourth embodiment;

FIG. 7 comprises bottom views showing other practical examples of a preform according to the fourth embodiment; and

FIG. 8 comprises diagrams showing a procedure for the fabrication of a cover glass according to a fifth embodiment of the present invention.

### DESCRIPTION OF EMBODIMENTS

Hereinafter, a method for fabricating a glass component according to the present invention will be described with reference to the accompanying drawings. Such parts as are identical or equivalent among different embodiments or examples are identified by common reference signs, and no overlapping description will be repeated unless necessary.

### First Embodiment

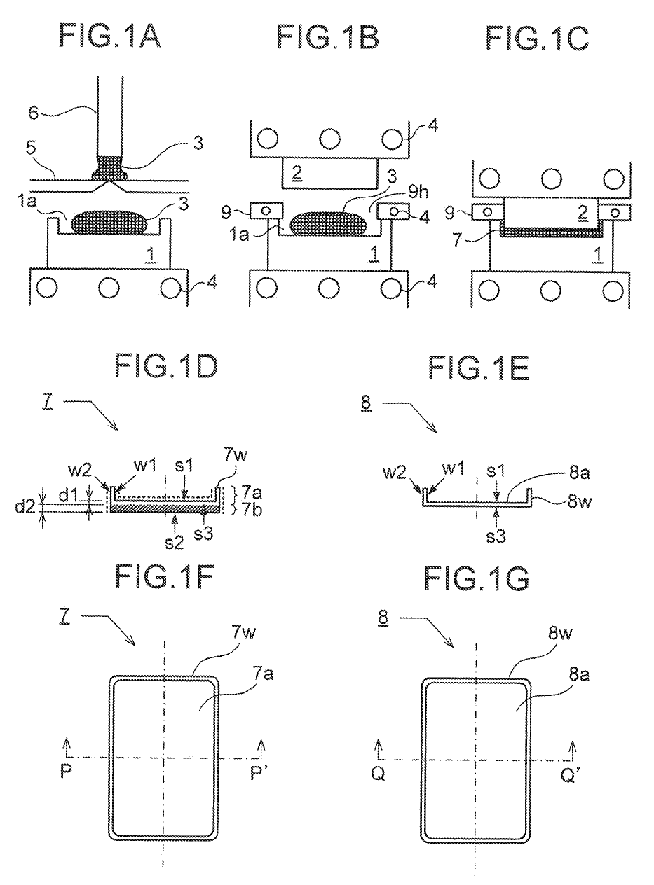

FIGS. 1A to 1G show a method of fabricating a cover glass 8 according to a first embodiment of the present invention. This fabrication method includes a molding process shown in sectional views in FIGS. 1A to 1C and a working process shown in sectional views in FIGS. 1D and 1E and in plan views in FIGS. 1F and 1G. Through the molding process, which includes a dropping process (A), a moving process (B), and a pressing process (C), a preform (sheet glass blank) 7 is formed by direct pressing; through the working process (D) to (G), a cover glass 8 as a finished product is formed which is composed of a cover main body 8a having a main face s1 as a molded face and an upright wall 8w formed to extend from a peripheral part of the cover main body 8a. FIG. 1D is a sectional view across line P-P′ in FIG. 1F, and FIG. 1E is a sectional view across line Q-Q′ in FIG. 1G.

The cover glass 8 is, for example, a glass-made cover member used to cover the image display surface of digital appliances having an image display function (e.g., portable electronic appliances such as cellular telephones, smartphones, and mobile computers). That is, the cover glass 8 is for protection of an image display surface, but the use of a glass-made cover member is not limited to as a cover glass for an image display surface: it can also be used, for example, as an exterior cover for digital appliances. The main face s1 is one face as a face that covers an image display surface, and although it is assumed to be a flat face here, it may instead be a curved face.

First, in the dropping process (A), a predetermined amount of molten glass 3 is dropped into a depression 1a in a lower mold 1. That is, molten glass 3 obtained by melting in a furnace is poured out through a platinum nozzle 6 and cut with a blade 5 so that a predetermined amount of molten glass 3 is dropped into the depression 1a in the lower mold 1. To prevent the molten glass 3 from being cooled rapidly by the lower mold 1, the lower mold 1 is heated by a heater 4. Thus, the molten glass 3 in the depression 1a is maintained/controlled to be in a state where a predetermined viscosity is maintained.

In the subsequent moving process (B), the lower mold 1 is moved to a predetermined position under an upper mold 2, and an outer mold 9 having a rectangular opening 9h is placed on the lower mold 1. Like the lower mold 1, the upper mold 2 and the outer mold 9 are heated by a heater 4 to prevent the molten glass 3 from being cooled rapidly. Accordingly, the molten glass 3 in the depression 1a is maintained/controlled to be in a state where a predetermined viscosity is maintained even in contact with the upper mold 2 etc. Also, through temperature control by the heater 4, it is possible to stabilize the clearance between the upper mold 2 and the outer mold 9.

After the lower mold 1 is left to stand for a predetermined period in the moving process (B), the pressing process (C) starts. In the pressing process (C), the upper mold 2 is lowered so that the upper mold 2 passes through the opening 9h in the outer mold 9, and the molten glass 3 in the depression 1a in the lower mold 1 is pressed by the upper mold 2. Through this pressing, the space enclosed by the lower mold 1, the upper mold 2, and the outer mold 9 is filled by the molten glass 3, and thereby a preform 7 is formed which is composed of the molding main body 7a (FIGS. 1D and 1F) corresponding to the cover glass 8 (FIGS. 1E and 1G) and a to-be-worked portion 7b unnecessary for the cover glass 8. Here, the extent of the molten glass 3 is restricted by the inner wall face of the outer mold 9, so that the mold-enclosed space is filled by the molten glass 3. By appropriately setting the dimension of the mold-to-mold clearance, it is possible to exhaust air from the mold-enclosed space easily while holding the molten glass 3 there stably.

The wall thickness of the to-be-worked portion 7b of the preform 7 (i.e., the thickness from the reverse face s2 to the reverse face s3) is set at a predetermined dimension with high freedom. If temperature drops as the molten glass 3 is dropped onto the lower mold 1, moldability diminishes, making it difficult to make the molten glass 3 as thin as a predetermined thickness (i.e., the thickness from the main face s1 to the reverse face s3). To prevent that, in this embodiment, the sheet thickness is set larger than that of the cover glass 8 as the finished product so that, by grinding or polishing the set to-be-worked portion 7b in the working process (D) to (G), the to-be-worked portion 7b can be removed from the preform 7. The larger sheet thickness helps prevent a drop in the temperature of the molten glass, and makes it possible to fill glass in the mold-enclosed space forming the upright wall 8w.

As a result of the filling with the molten glass 3 in the pressing process (C), as shown in FIG. 1D, the inner wall face w1 of an upright wall 7w and the main face s1 are molded by the upper mold 2, the outer wall face w2 of the upright wall 7w and the reverse face s2 of the main face s1 are molded by the lower mold 1, and on the reverse face s2 side of the main face s1, the to-be-worked portion 7b is left. Of the entire surface of the preform 7, the faces indicated by broken lines (FIG. 1D), i.e., the inner wall face w1 and the outer wall face w2 of the upright wall 7w and the main face s1, are mirror-molded faces transferred from the lower mold 1 and the upper mold 2.

The surface roughness of the reverse face s2 molded by the lower mold 1 tends to be worse than that of the main face s1 molded by the upper mold 2. This results from the former being more influenced by the molten glass 3 being cooled by the lower mold 1 when spreading during pressing. On the other hand, the main face s1, which is a face molded by the upper mold 2, is hardly influenced by the cooling of the glass, and thus becomes a mirror surface. The main face s1 and the inner wall face w1 of the upright wall 7w are difficult to polish into a mirror surface, but since they are faces molded by the upper mold 2, they do not require polishing. As for the reverse face s2, which is a face molded by the lower mold 1, even when molding does not make it a mirror surface, it can be polished into a mirror surface.

In the pressing process (C), the end part shape of the upright wall 7w is restricted by the outer mold 9. With the space enclosed by the lower mold 1, the upper mold 2, and the outer mold 9 filled with the molten glass 3, restricting the end part shape of the upright wall 7w by the outer mold 9 allows the molten glass 3 to spread evenly throughout the mold-enclosed space, and this results in better moldability with the molten glass 3. Moreover, even if an uneven temperature distribution in the molten glass 3 causes an uneven flow of the molten glass 3, the outer mold 9 restricts the flow of the molten glass 3, which thus spreads up to every corner in the mold-enclosed space. This makes the molding of the preform 7 easier.

The preform 7 obtained through the pressing process (C) is released from the molds and taken out, and then the working process (D) to (G) starts. As shown in FIGS. 1D and 1F, the preform 7 is composed of the molding main body 7a and the to-be-worked portion 7b (hatched). In the working process (D) to (G), at least either flat-face grinding or flat-face polishing is performed to completely remove the to-be-worked portion 7b, which is an unnecessary part, from the preform 7 (i.e., by grinding or polishing the to-be-worked portion 7b from the reverse face s2 side of the main face s1, the to-be-worked portion 7b is removed from the preform 7). This leaves the molding main body 7a alone; that is, as shown in FIGS. 1E and 1G, the cover glass 8 as a finished product is formed. As shown in FIGS. 1E and 1G, the cover glass 8 is composed of the cover main body 8a having the main face s1 and its reverse face s3 and the upright wall 8w formed to extend from the peripheral part of the cover main body 8a.

The flat-face grinding or flat-face polishing on the to-be-worked portion 7b is performed on the reverse face s2, which has been in contact with the bottom face of the depression 1a, and involves first roughly flat-surface-grinding, with a polishing pad, a plurality of preforms 7 together and then finely flat-surface-polishing them. Switching from flat-face grinding to flat-face polishing is easily achieved by changing the polishing liquid applied to the reverse face s2. In a case where the reverse face s3 of the cover glass 8 need not be made a mirror surface, a coat may be formed on the reverse face s3 to obtain desired smoothness. In a case where the reverse face s3 of the cover glass 8 is made a curved surface, curved-face grinding or curved-face polishing can be performed on the to-be-worked portion 7b.

Through the filling with the molten glass 3 in the pressing process (C), the inner wall face w1 of the upright wall 8w and the main face s1 are molded by the upper mold 2, and thus no bending is necessary. Moreover, the to-be-worked portion 7b removed by grinding or polishing in the working process (D) to (G) is located on the reverse face s2 side of the main face s1 in the pressing process (C), and thus not only the working process (D) to (G) but also molding in the pressing process (C) can be performed satisfactorily and easily. Thus, with the configuration according to this embodiment, it is easy to fabricate a box-shaped cover glass 8 with a small radius of curvature at the boundary between the inner wall face w1 of the upright wall 8w and the main face s1 and with satisfactory exterior appearance quality.

The main face s1 and the inner wall face w1 are both formed by the upper mold 2, and thus the high precision of the upper mold 2 can be reflected on the surface accuracy of the main face s1 and the inner wall face w1 of the cover glass 8. For example, it is possible to perform molding so as to make the boundary face between the main face s1 and the inner wall face w1 a smooth curved surface. Thus, with the configuration according to this embodiment, it is possible to control and in addition improve the accuracy of the main face s1 and the inner wall face w1 of the cover glass 8. This configuration is particularly effective in the molding of high-viscosity glass, which is difficult to control.

The reverse face s3 of the cover glass 8 is formed by performing flat-face grinding or flat-face polishing on the to-be-worked portion 7b from the reverse face s2 side of the preform 7. When, in the working process (D) to (G), the to-be-worked portion 7b is removed from the preform 7 by grinding or polishing, it is preferable to remove the to-be-worked portion 7b with reference to the main face s1. By removing the to-be-worked portion 7b with reference to the main face s1, it is possible to accurately and easily control the thickness of the cover glass 8 (i.e., the thickness from the main face s1 to the reverse face s3).

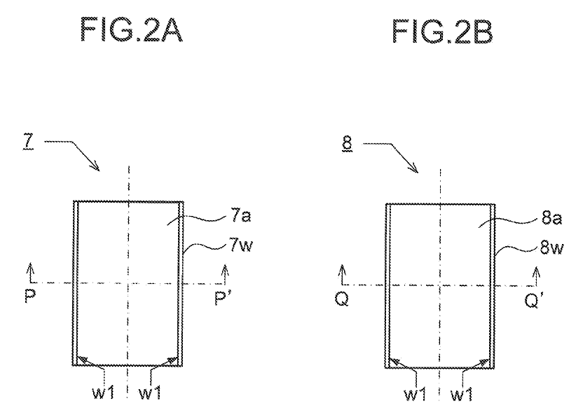

The cover glass 8 is shaped like a box, but may instead have a U-shaped sectional shape. The upright wall 7w of the preform 7 shown in FIG. 1F is provided around the entire circumference of the molding main body 7a, and the upright wall 8w of the cover glass 8 shown in FIG. 1G is formed around the entire circumference of the cover main body 8a. The inner wall face w1 comprises two pairs of faces, the two faces in each pair located opposite each other, so as to correspond to the rectangular shape of the image display surface. Instead, like the upright wall 7w of the preform 7 shown in FIG. 2A and the upright wall 8w of the cover glass 8 shown in FIG. 2B, the inner wall face w1 may comprise a single pair of faces located opposite each other so as to correspond to the rectangular shape of the image display surface.

It is preferable that the thickness d1+d2 (FIG. 1D) of the preform 7 from the main face s1 to its reverse face s2 be three to seven times the thickness d1 of the molding main body 7a from the main face s1 to its reverse face s3. With (d1+d2)/d1 smaller than 3, it is difficult to press and spread molten glass 3. This makes it difficult to perform pressing evenly over the entire surface, and thus results in lower surface accuracy. With (d1+d2)/d1 larger than 7, much of the molten glass 3 is wasted during working. Moreover, the large amount of heat leads to a large amount of shrinkage in the molten glass 3, and this lowers the surface accuracy of the main face s1 as the molded face.

### Second Embodiment

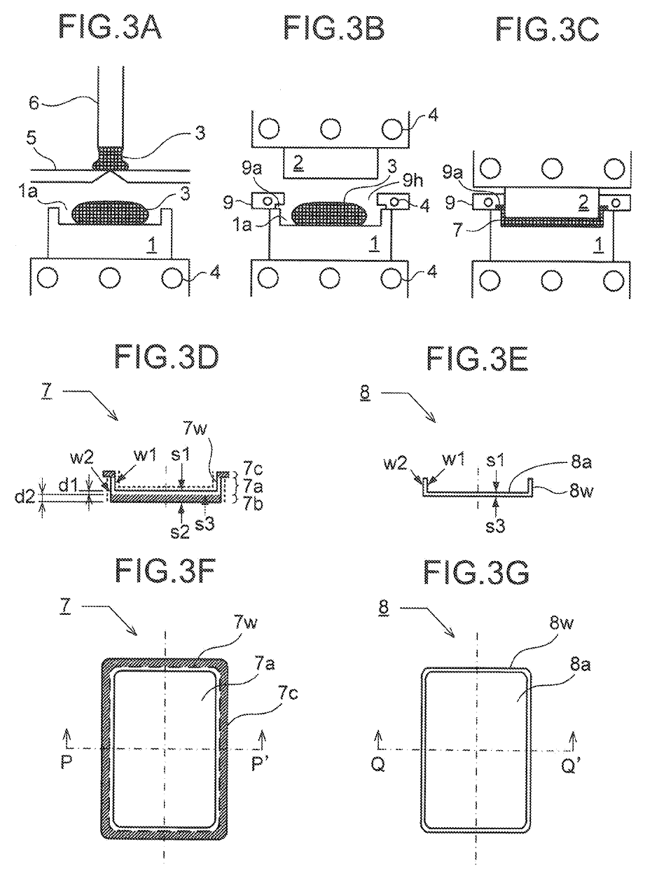

FIGS. 3A to 3G show a method of fabricating a cover glass 8 according to a second embodiment of the present invention. This fabrication method includes a molding process shown in sectional views in FIGS. 3A to 3C and a working process shown in sectional views in FIGS. 3D and 3E and in plan views in FIGS. 3F and 3G. Through the molding process, which includes a dropping process (A), a moving process (B), and a pressing process (C), a preform (sheet glass blank) 7 is formed by direct pressing; through the working process (D) to (G), a cover glass 8 as a finished product is formed which is composed of a cover main body 8a having a main face s1 as a molded face and an upright wall 8w formed to extend from a peripheral part of the cover main body 8a. FIG. 3D is a sectional view across line P-P′ in FIG. 3F, and FIG. 3E is a sectional view across line Q-Q′ in FIG. 3G.

The cover glass 8 is, for example, a glass-made cover member used to cover the image display surface of digital appliances having an image display function (e.g., portable electronic appliances such as cellular telephones, smartphones, and mobile computers). That is, the cover glass 8 is for protection of an image display surface, but the use of a glass-made cover member is not limited to as a cover glass for an image display surface: it can also be used, for example, as an exterior cover for digital appliances. The main face s1 is one face as a face that covers an image display surface, and although it is assumed to be a flat face here, it may instead be a curved face.

First, in the dropping process (A), a predetermined amount of molten glass 3 is dropped into a depression 1a in a lower mold 1. That is, molten glass 3 obtained by melting in a furnace is poured out through a platinum nozzle 6 and cut with a blade 5 so that a predetermined amount of molten glass 3 is dropped into the depression 1a in the lower mold 1. To prevent the molten glass 3 from being cooled rapidly by the lower mold 1, the lower mold 1 is heated by a heater 4. Thus, the molten glass 3 in the depression 1a is maintained/controlled to be in a state where a predetermined viscosity is maintained.

In the subsequent moving process (B), the lower mold 1 is moved to a predetermined position under an upper mold 2, and an outer mold 9 having a rectangular opening 9h and a recess 9a is placed on the lower mold 1. Like the lower mold 1, the upper mold 2 and the outer mold 9 are heated by a heater 4 to prevent the molten glass 3 from being cooled rapidly. Accordingly, the molten glass 3 in the depression 1a is maintained/controlled to be in a state where a predetermined viscosity is maintained even in contact with the upper mold 2 etc. Also, through temperature control by the heater 4, it is possible to stabilize the clearance between the upper mold 2 and the outer mold 9.

After the lower mold 1 is left to stand for a predetermined period in the moving process (B), the pressing process (C) starts. In the pressing process (C), the upper mold 2 is lowered so that the upper mold 2 passes through the opening 9h in the outer mold 9, and the molten glass 3 in the depression 1a in the lower mold 1 is pressed by the upper mold 2. Through this pressing, the space enclosed by the lower mold 1, the upper mold 2, and the outer mold 9 is filled by the molten glass 3, and thereby a preform 7 is formed which is composed of the molding main body 7a (FIGS. 3D and 3F) corresponding to the cover glass 8 (FIGS. 3E and 3G) and a to-be-worked portion 7b and an excess portion 7c unnecessary for the cover glass 8. Here, the extent of the molten glass 3 is restricted by the inner wall face of the outer mold 9, so that the mold-enclosed space is filled by the molten glass 3. By appropriately setting the dimension of the mold-to-mold clearance, it is possible to exhaust air from the mold-enclosed space easily while holding the molten glass 3 there stably.

The wall thickness of the to-be-worked portion 7b of the preform 7 (i.e., the thickness from the reverse face s2 to the reverse face s3) is set at a predetermined dimension with high freedom. If temperature drops as the molten glass 3 is dropped onto the lower mold 1, moldability diminishes, making it difficult to make the molten glass 3 as thin as a predetermined thickness (i.e., the thickness from the main face s1 to the reverse face s3). To prevent that, in this embodiment, the sheet thickness is set larger than that of the cover glass 8 as the finished product so that, by grinding or polishing the set to-be-worked portion 7b in the working process (D) to (G), the to-be-worked portion 7b can be removed from the preform 7. The larger sheet thickness helps prevent a drop in the temperature of the molten glass, and makes it possible to fill glass in the mold-enclosed space forming the upright wall 8w.

As a result of the filling with the molten glass 3 in the pressing process (C), as shown in FIG. 3D, the inner wall face w1 of an upright wall 7w and the main face s1 are molded by the upper mold 2, the outer wall face w2 of the upright wall 7w and the reverse face s2 of the main face s1 are molded by the lower mold 1, and on the reverse face s2 side of the main face s1, the to-be-worked portion 7b is left. Of the entire surface of the preform 7, the faces indicated by broken lines (FIG. 3D), i.e., the inner wall face w1 and the outer wall face w2 of the upright wall 7w and the main face s1, are mirror-molded faces transferred from the lower mold 1 and the upper mold 2.

The surface roughness of the reverse face s2 molded by the lower mold 1 tends to be worse than that of the main face s1 molded by the upper mold 2. This results from the former being more influenced by the molten glass 3 being cooled by the lower mold 1 when spreading during pressing. On the other hand, the main face s1, which is a face molded by the upper mold 2, is hardly influenced by the cooling of the glass, and thus becomes a mirror surface. The main face s1 and the inner wall face w1 of the upright wall 7w are difficult to polish into a mirror surface, but since they are faces molded by the upper mold 2, they do not require polishing. As for the reverse face s2, which is a face molded by the lower mold 1, even when molding does not make it a mirror surface, it can be polished into a mirror surface.

In the pressing process (C), the end part shape of the upright wall 7w is restricted by the outer mold 9. With the space enclosed by the lower mold 1, the upper mold 2, and the outer mold 9 filled with the molten glass 3, restricting the end part shape of the upright wall 7w by the outer mold 9 allows the molten glass 3 to spread evenly throughout the mold-enclosed space, and this results in better moldability with the molten glass 3. Moreover, even if an uneven temperature distribution in the molten glass 3 causes an uneven flow of the molten glass 3, the outer mold 9 restricts the flow of the molten glass 3, which thus spreads up to every corner in the mold-enclosed space. This makes the molding of the preform 7 easier.

The molten glass 3 that has risen along the inner wall face of the depression 1a is restricted by the outer mold 9, and meanwhile flows into the recess 9a provided as an excess glass space in the outer mold 9 (FIG. 3C). As a result, as shown in FIG. 3D, an excess portion 7c is formed. In this way, in the pressing process (C), it is preferable to form, with the outer mold 9, an unnecessary excess portion 7c on the cover glass 8 in an end part of the upright wall 7w. This helps improve the flow of the molten glass 3, and in addition helps increase the heat capacity of a circumferential part and thereby make the upright wall 7w less likely to crack, facilitating thin wall molding.

The preform 7 obtained through the pressing process (C) is released from the molds and taken out, and then the working process (D) to (G) starts. As shown in FIGS. 3D and 3F, the preform 7 is composed of the molding main body 7a, the to-be-worked portion 7b (hatched), and the excess portion 7c (hatched). In the working process (D) to (G), at least either flat-face grinding or flat-face polishing is performed to completely remove the to-be-worked portion 7b and the excess portion 7c, which are unnecessary parts, from the preform 7 (i.e., by grinding or polishing the to-be-worked portion 7b from the reverse face s2 side of the main face s1, the to-be-worked portion 7b is removed from the preform 7; by grinding or polishing the excess portion 7c from the main face s1 side, the excess portion 7c is removed from the preform 7). This leaves the molding main body 7a alone; that is, as shown in FIGS. 3E and 3G, the cover glass 8 as a finished product is formed. As shown in FIGS. 3E and 3G, the cover glass 8 is composed of the cover main body 8a having the main face s1 and its reverse face s3 and the upright wall 8w formed to extend from the peripheral part of the cover main body 8a.

The flat-face grinding or flat-face polishing on the to-be-worked portion 7b is performed on the reverse face s2, which has been in contact with the bottom face of the depression 1a, and involves first roughly flat-surface-grinding, with a polishing pad, a plurality of preforms 7 together and then finely flat-surface-polishing them. Switching from flat-face grinding to flat-face polishing is easily achieved by changing the polishing liquid applied to the reverse face s2. In a case where the reverse face s3 of the cover glass 8 need not be made a mirror surface, a coat may be formed on the reverse face s3 to obtain desired smoothness. In a case where the reverse face s3 of the cover glass 8 is made a curved surface, curved-face grinding or curved-face polishing can be performed on the to-be-worked portion 7b.

Through the filling with the molten glass 3 in the pressing process (C), the inner wall face w1 of the upright wall 8w and the main face s1 are molded by the upper mold 2, and thus no bending is necessary. Moreover, the to-be-worked portion 7b removed by grinding or polishing in the working process (D) to (G) is located on the reverse face s2 side of the main face s1 in the pressing process (C), and thus not only the working process (D) to (G) but also molding in the pressing process (C) can be performed satisfactorily and easily. Thus, with the configuration according to this embodiment, it is easy to fabricate a box-shaped cover glass 8 with a small radius of curvature at the boundary between the inner wall face w1 of the upright wall 8w and the main face s1 and with satisfactory exterior appearance quality.

The main face s1 and the inner wall face w1 are both formed by the upper mold 2, and thus the high precision of the upper mold 2 can be reflected on the surface accuracy of the main face s1 and the inner wall face w1 of the cover glass 8. For example, it is possible to perform molding so as to make the boundary face between the main face s1 and the inner wall face w1 a smooth curved surface. Thus, with the configuration according to this embodiment, it is possible to control and in addition improve the accuracy of the main face s1 and the inner wall face w1 of the cover glass 8. This configuration is particularly effective in the molding of high-viscosity glass, which is difficult to control.

The reverse face s3 of the cover glass 8 is formed by performing flat-face grinding or flat-face polishing on the to-be-worked portion 7b from the reverse face s2 side of the preform 7. When, in the working process (D) to (G), the to-be-worked portion 7b is removed from the preform 7 by grinding or polishing, it is preferable to remove the to-be-worked portion 7b with reference to the main face s1. By removing the to-be-worked portion 7b with reference to the main face s1, it is possible to accurately and easily control the thickness of the cover glass 8 (i.e., the thickness from the main face s1 to the reverse face s3).

In the working process (D) to (G), it is preferable to remove the excess portion 7c by grinding or polishing it parallel to the main face s1. By removing the excess portion 7c parallel to the excess portion 7c, it is possible to control the height of the cover glass 8 accurately and easily.

Moreover, in the working process (D) to (G), it is preferable to remove the excess portion 7c with reference to the reverse face S3 (exposed face) of the molding main body 7a after removal of the to-be-worked portion 7b. Since the reverse face S3 is formed with reference to the main face s1, by removing the excess portion 7c with reference to the reverse face S3, it is possible to control the height of the cover glass 8 accurately and easily.

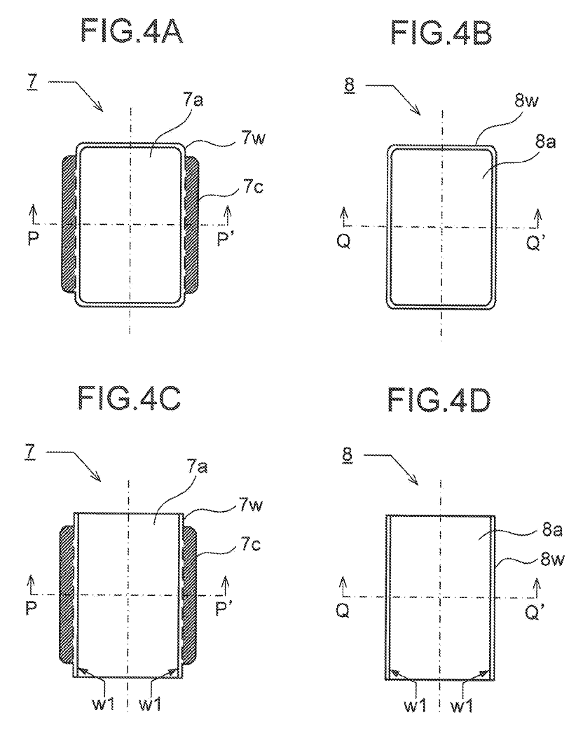

As shown in FIG. 3F, the excess portion 7c of the preform 7 is formed around the entire circumference of the molding main body 7a; instead, it may be formed on part of the molding main body 7a as shown in FIGS. 4A and 4C. With respect to the preform 7 and the cover glass 8 shown in FIGS. 4A to 4D, FIG. 3D corresponds to a sectional view across line P-P′ in FIGS. 4A and 4C, and FIG. 3E corresponds to a sectional view across line Q-Q′ in FIG. 4B and FIG. 4D.

The cover glass 8 is shaped like a box, but may instead have a U-shaped sectional shape. The upright wall 7w of the preform 7 shown in FIG. 3F is provided around the entire circumference of the molding main body 7a, and the upright wall 8w of the cover glass 8 shown in FIG. 3G is formed around the entire circumference of the cover main body 8a. The inner wall face w1 comprises two pairs of faces, the two faces in each pair located opposite each other, so as to correspond to the rectangular shape of the image display surface. Instead, like the upright wall 7w of the preform 7 shown in FIG. 4C and the upright wall 8w of the cover glass 8 shown in FIG. 4D, the inner wall face w1 may comprise a single pair of faces located opposite each other so as to correspond to the rectangular shape of the image display surface.

It is preferable that the thickness d1+d2 (FIG. 3D) of the preform 7 from the main face s1 to its reverse face s2 be three to seven times the thickness d1 of the molding main body 7a from the main face s1 to its reverse face s3. With (d1+d2)/d1 smaller than 3, it is difficult to press and spread molten glass 3. This makes it difficult to perform pressing evenly over the entire surface, and thus results in lower surface accuracy. With (d1+d2)/d1 larger than 7, much of the molten glass 3 is wasted during working. Moreover, the large amount of heat leads to a large amount of shrinkage in the molten glass 3, and this lowers the surface accuracy of the main face s1 as the molded face.

### Third Embodiment

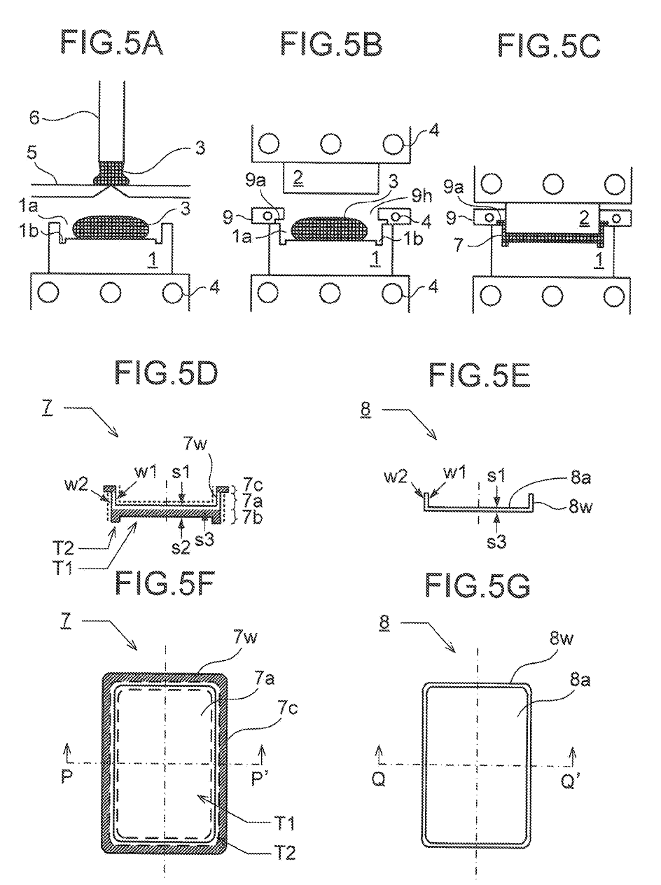

FIGS. 5A to 5G show a method of fabricating a cover glass 8 according to a third embodiment of the present invention. This fabrication method includes a molding process shown in sectional views in FIGS. 5A to 5C and a working process shown in sectional views in FIGS. 5D and 5E and in plan views in FIGS. 5F and 5G. Through the molding process, which includes a dropping process (A), a moving process (B), and a pressing process (C), a preform (sheet glass blank) 7 is formed by direct pressing; through the working process (D) to (G), a cover glass 8 as a finished product is formed which is composed of a cover main body 8a having a main face s1 as a molded face and an upright wall 8w formed to extend from a peripheral part of the cover main body 8a. FIG. 5D is a sectional view across line P-P′ in FIG. 5F, and FIG. 5E is a sectional view across line Q-Q′ in FIG. 5G.

The cover glass 8 is, for example, a glass-made cover member used to cover the image display surface of digital appliances having an image display function (e.g., portable electronic appliances such as cellular telephones, smartphones, and mobile computers). That is, the cover glass 8 is for protection of an image display surface, but the use of a glass-made cover member is not limited to as a cover glass for an image display surface: it can also be used, for example, as an exterior cover for digital appliances. The main face s1 is one face as a face that covers an image display surface, and although it is assumed to be a flat face here, it may instead be a curved face.

First, in the dropping process (A), a predetermined amount of molten glass 3 is dropped into a depression 1a in a lower mold 1. That is, molten glass 3 obtained by melting in a furnace is poured out through a platinum nozzle 6 and cut with a blade 5 so that a predetermined amount of molten glass 3 is dropped into the depression 1a in the lower mold 1. To prevent the molten glass 3 from being cooled rapidly by the lower mold 1, the lower mold 1 is heated by a heater 4. Thus, the molten glass 3 in the depression 1a is maintained/controlled to be in a state where a predetermined viscosity is maintained. Here, in the depression 1a in the lower mold 1, a rectangular frame-shaped depression 1b is formed along the edges of its bottom face.

In the subsequent moving process (B), the lower mold 1 is moved to a predetermined position under an upper mold 2, and an outer mold 9 having a rectangular opening 9h and a recess 9a is placed on the lower mold 1. Like the lower mold 1, the upper mold 2 and the outer mold 9 are heated by a heater 4 to prevent the molten glass 3 from being cooled rapidly. Accordingly, the molten glass 3 in the depression 1a is maintained/controlled to be in a state where a predetermined viscosity is maintained even in contact with the upper mold 2 etc. Also, through temperature control by the heater 4, it is possible to stabilize the clearance between the upper mold 2 and the outer mold 9.

After the lower mold 1 is left to stand for a predetermined period in the moving process (B), the pressing process (C) starts. In the pressing process (C), the upper mold 2 is lowered so that the upper mold 2 passes through the opening 9h in the outer mold 9, and the molten glass 3 in the depression 1a in the lower mold 1 is pressed by the upper mold 2. Through this pressing, the space enclosed by the lower mold 1, the upper mold 2, and the outer mold 9 is filled by the molten glass 3, and thereby a preform 7 is formed which is composed of the molding main body 7a (FIGS. 5D and 5F) corresponding to the cover glass 8 (FIGS. 5E and 5G) and a to-be-worked portion 7b and an excess portion 7c unnecessary for the cover glass 8. Here, the extent of the molten glass 3 is restricted by the inner wall face of the outer mold 9, so that the mold-enclosed space is filled by the molten glass 3. By appropriately setting the dimension of the mold-to-mold clearance, it is possible to exhaust air from the mold-enclosed space easily while holding the molten glass 3 there stably.

The wall thickness of the to-be-worked portion 7b of the preform 7 (i.e., the thickness from the reverse face s2 to the reverse face s3) is set at a predetermined dimension with high freedom. If temperature drops as the molten glass 3 is dropped onto the lower mold 1, moldability diminishes, making it difficult to make the molten glass 3 as thin as a predetermined thickness (i.e., the thickness from the main face s1 to the reverse face s3). To prevent that, in this embodiment, the sheet thickness is set larger than that of the cover glass 8 as the finished product so that, by grinding or polishing the set to-be-worked portion 7b in the working process (D) to (G), the to-be-worked portion 7b can be removed from the preform 7. The larger sheet thickness helps prevent a drop in the temperature of the molten glass, and makes it possible to fill glass in the mold-enclosed space forming the upright wall 8w.

As a result of the filling with the molten glass 3 in the pressing process (C), as shown in FIG. 5D, the inner wall face w1 of an upright wall 7w and the main face s1 are molded by the upper mold 2, the outer wall face w2 of the upright wall 7w and the reverse face s2 of the main face s1 are molded by the lower mold 1, and on the reverse face s2 side of the main face s1, the to-be-worked portion 7b is left. This reverse face s2 on the to-be-worked portion 7b is composed of a rectangular depression T1 and a frame-shaped elevation T2 surrounding it, which are formed by the molten glass 3 filling the depression 1b in the lower mold 1. Of the entire surface of the preform 7, the faces indicated by broken lines (FIG. 5D), i.e., the inner wall face w1 and the outer wall face w2 of the upright wall 7w and the main face s1, are mirror-molded faces transferred from the lower mold 1 and the upper mold 2.

The surface roughness of the reverse face s2 molded by the lower mold 1 tends to be worse than that of the main face s1 molded by the upper mold 2. This results from the former being more influenced by the molten glass 3 being cooled by the lower mold 1 when spreading during pressing. On the other hand, the main face s1, which is a face molded by the upper mold 2, is hardly influenced by the cooling of the glass, and thus becomes a mirror surface. The main face s1 and the inner wall face w1 of the upright wall 7w are difficult to polish into a mirror surface, but since they are faces molded by the upper mold 2, they do not require polishing. As for the reverse face s2, which is a face molded by the lower mold 1, even when molding does not make it a mirror surface, it can be polished into a mirror surface.

In the pressing process (C), the end part shape of the upright wall 7w is restricted by the outer mold 9. With the space enclosed by the lower mold 1, the upper mold 2, and the outer mold 9 filled with the molten glass 3, restricting the end part shape of the upright wall 7w by the outer mold 9 allows the molten glass 3 to spread evenly throughout the mold-enclosed space, and this results in better moldability with the molten glass 3. Moreover, even if an uneven temperature distribution in the molten glass 3 causes an uneven flow of the molten glass 3, the outer mold 9 restricts the flow of the molten glass 3, which thus spreads up to every corner in the mold-enclosed space. This makes the molding of the preform 7 easier.

The molten glass 3 that has risen along the inner wall face of the depression 1a is restricted by the outer mold 9, and meanwhile flows into the recess 9a provided as an excess glass space in the outer mold 9 (FIG. 5C). As a result, as shown in FIG. 5D, an excess portion 7c is formed. In this way, in the pressing process (C), it is preferable to form, with the outer mold 9, an unnecessary excess portion 7c on the cover glass 8 in an end part of the upright wall 7w. This helps improve the flow of the molten glass 3, and in addition helps increase the heat capacity of a circumferential part and thereby make the upright wall 7w less likely to crack, facilitating thin wall molding.

The preform 7 obtained through the pressing process (C) is released from the molds and taken out, and then the working process (D) to (G) starts. As shown in FIGS. 5D and 5F, the preform 7 is composed of the molding main body 7a, the to-be-worked portion 7b (hatched), and the excess portion 7c (hatched). As mentioned above, the reverse face s2 on the to-be-worked portion 7b is composed of the rectangular depression T1 and the frame-shaped elevation T2 surrounding it. In the working process (D) to (G), at least either flat-face grinding or flat-face polishing is performed to completely remove the to-be-worked portion 7b and the excess portion 7c, which are unnecessary parts, from the preform 7 (i.e., by grinding or polishing the to-be-worked portion 7b from the reverse face s2 side of the main face s1, the to-be-worked portion 7b is removed from the preform 7; by grinding or polishing the excess portion 7c from the main face s1 side, the excess portion 7c is removed from the preform 7). This leaves the molding main body 7a alone; that is, as shown in FIGS. 5E and 5G, the cover glass 8 as a finished product is formed. As shown in FIGS. 5E and 5G, the cover glass 8 is composed of the cover main body 8a having the main face s1 and its reverse face s3 and the upright wall 8w formed to extend from the peripheral part of the cover main body 8a.

The flat-face grinding or flat-face polishing on the to-be-worked portion 7b is performed on the reverse face s2, which has been in contact with the bottom face of the depression 1a, and involves first roughly flat-surface-grinding, with a polishing pad or a polishing whetstone, a plurality of preforms 7 together and then finely flat-surface-polishing them with a polishing pad. Switching from flat-face grinding to flat-face polishing is easily achieved by changing the polishing liquid applied to the reverse face s2. In a case where the reverse face s3 of the cover glass 8 need not be made a mirror surface, a coat may be formed on the reverse face s3 to obtain desired smoothness. In a case where the reverse face s3 of the cover glass 8 is made a curved surface, curved-face grinding or curved-face polishing can be performed on the to-be-worked portion 7b.

Through the filling with the molten glass 3 in the pressing process (C), the inner wall face w1 of the upright wall 8w and the main face s1 are molded by the upper mold 2, and thus no bending is necessary. Moreover, the to-be-worked portion 7b removed by grinding or polishing in the working process (D) to (G) is located on the reverse face s2 side of the main face s1 in the pressing process (C), and thus not only the working process (D) to (G) but also molding in the pressing process (C) can be performed satisfactorily and easily. Thus, with the configuration according to this embodiment, it is easy to fabricate a box-shaped cover glass 8 with a small radius of curvature at the boundary between the inner wall face w1 of the upright wall 8w and the main face s1 and with satisfactory exterior appearance quality.

The main face s1 and the inner wall face w1 are both formed by the upper mold 2, and thus the high precision of the upper mold 2 can be reflected on the surface accuracy of the main face s1 and the inner wall face w1 of the cover glass 8. For example, it is possible to perform molding so as to make the boundary face between the main face s1 and the inner wall face w1 a smooth curved surface. Thus, with the configuration according to this embodiment, it is possible to control and in addition improve the accuracy of the main face s1 and the inner wall face w1 of the cover glass 8. This configuration is particularly effective in the molding of high-viscosity glass, which is difficult to control.

The reverse face s3 of the cover glass 8 is formed by performing flat-face grinding or flat-face polishing on the to-be-worked portion 7b from the reverse face s2 side of the preform 7. When, in the working process (D) to (G), the to-be-worked portion 7b is removed from the preform 7 by grinding or polishing, it is preferable to remove the to-be-worked portion 7b with reference to the main face s1. By removing the to-be-worked portion 7b with reference to the main face s1, it is possible to accurately and easily control the thickness of the cover glass 8 (i.e., the thickness from the main face s1 to the reverse face s3).

In the working process (D) to (G), it is preferable to remove the excess portion 7c by grinding or polishing it parallel to the main face s1. By removing the excess portion 7c parallel to the excess portion 7c, it is possible to control the height of the cover glass 8 accurately and easily.

Moreover, in the working process (D) to (G), it is preferable to remove the excess portion 7c with reference to the reverse face S3 (exposed face) of the molding main body 7a after removal of the to-be-worked portion 7b. Since the reverse face S3 is formed with reference to the main face s1, by removing the excess portion 7c with reference to the reverse face S3, it is possible to control the height of the upright wall 8 accurately and easily.

As shown in FIG. 5F, the excess portion 7c of the preform 7 is formed around the entire circumference of the molding main body 7a; instead, it may be formed on part of the molding main body 7a. The cover glass 8 is shaped like a box, but may instead have a U-shaped sectional shape. The inner wall face w1 may comprise a single pair of faces located opposite each other so as to correspond to the rectangular shape of the image display surface.

It is preferable that the thickness d1+d2 (FIG. 5D) of the preform 7 from the main face s1 to its reverse face s2 be three to seven times the thickness d1 of the molding main body 7a from the main face s1 to its reverse face s3. With (d1+d2)/d1 smaller than 3, it is difficult to press and spread molten glass 3. This makes it difficult to perform pressing evenly over the entire surface, and thus results in lower surface accuracy. With (d1+d2)/d1 larger than 7, much of the molten glass 3 is wasted during working. Moreover, the large amount of heat leads to a large amount of shrinkage in the molten glass 3, and this lowers the surface accuracy of the main face s1 as the molded face.

By performing flat-face grinding or flat-face polishing on the reverse face s2 of the main face s1 formed by the upper mold 2, it is possible to obtain a high-accuracy surface shape both on the main face s1 and on the reverse face s2. However, to obtain sufficient accuracy on the main face s1, it is necessary to secure as large a molding thickness as possible, and the larger the molding thickness, the heavier the burden of working by grinding or polishing. Making the reverse face s2 a face having a depression T1 and an elevation T2 as in this embodiment helps alleviate the burden of working by grinding or polishing, and in addition the depression and elevation provide a dressing effect (an effect of eliminating mesh-clogging in the whetstone). Thus, using a preform 7 with a reverse face s2 having a depression T1 and an elevation T2 (FIGS. 5D and 5F) makes it easy to make the reverse face s2 flat at a predetermined position by flat-face grinding or flat-face polishing, and thus makes it possible to shorten the processing time and reduce the processing cost; it is thus easy to fabricate a cover glass 8 having a high-accuracy surface shape both on the main face s1 and on the reverse face s2.

Arranging an elevation T2 at the outermost circumference of the reverse face s2 as in this embodiment helps make a central part relatively thin, reduce the amount of glass shrinkage, alleviate glass solidification in a peripheral part, and also reduce warp in the preform 7, and this makes it easy to improve the transfer accuracy of the main face s1. The effect is particularly notable when the area occupied by the elevation T2 in the reverse face s2 is equal to or larger than one-fourth of the total area there.

The temperature of the lower mold 1 is lower than that of the dropped molten glass 3, and thus, once dropped, the molten glass 3 instantly starts to solidify. The molten glass 3 solidifies more easily in a peripheral part, and thus, if no elevation T2 is provided at the outermost circumference, during pressing with the upper mold 2, the molten glass 3 tends not to spread to the peripheral part, leading to poor transfer accuracy. Also in the molding thus pressed, the glass temperature is higher in a central part than in a peripheral part. As a result, glass exhibits a higher factor of shrinkage in a central part than in a peripheral part, and thus, after the completion of pressing (after the completion of the thrusting-in of the upper mold 2), glass in a central part exhibits a large amount of shrinkage, resulting in insufficient transfer of the mold pattern to, and a warp in, the preform 7. In this embodiment, owing to the provision of the elevation T2 at the outermost circumference, the outermost circumference has an increased thickness and thus has a larger heat capacity; this makes the circumferential part less prone to cool, and allows the molten glass 3 to spread to the peripheral part easily during pressing. Moreover, by making the central part thinner than the circumferential part, it is possible to strike a balance between the central part with a high factor of shrinkage and the peripheral part with a low factor of shrinkage; thus, the preform 7 as a whole exhibits an even amount of shrinkage, resulting in improved performance of transfer by molding.

By setting the area occupied by the elevation T2 in the reverse face s2 equal to or smaller than one-half of the area of the depression T1, it is possible to effectively achieve both surface accuracy and ease of processing. By giving the side face of the depression T1 a tapered shape at an angle of 3° or more relative to the line normal to the bottom face of the depression T1, it is possible to easily improve mold releasability.

### Fourth Embodiment

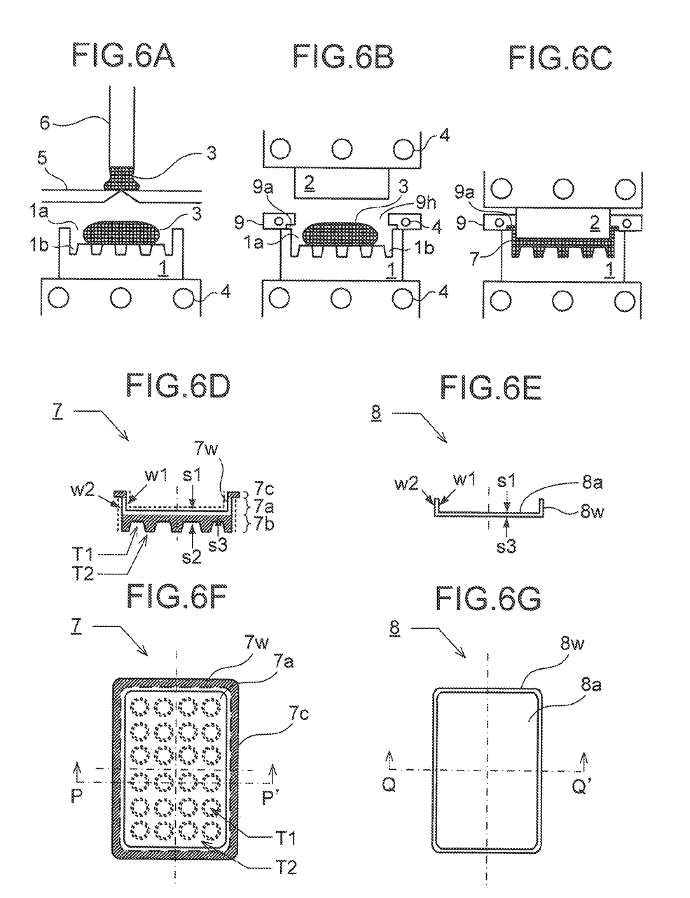

FIGS. 6A to 6G show a method of fabricating a cover glass 8 according to a fourth embodiment of the present invention. This fabrication method includes a molding process shown in sectional views in FIGS. 6A to 6C and a working process shown in sectional views in FIGS. 6D and 6E and in plan views in FIGS. 6F and 6G. Through the molding process, which includes a dropping process (A), a moving process (B), and a pressing process (C), a preform (sheet glass blank) 7 is formed by direct pressing; through the working process (D) to (G), a cover glass 8 as a finished product is formed which is composed of a cover main body 8a having a main face s1 as a molded face and an upright wall 8w formed to extend from a peripheral part of the cover main body 8a. FIG. 6D is a sectional view across line P-P′ in FIG. 6F, and FIG. 6E is a sectional view across line Q-Q′ in FIG. 6G.

The cover glass 8 is, for example, a glass-made cover member used to cover the image display surface of digital appliances having an image display function (e.g., portable electronic appliances such as cellular telephones, smartphones, and mobile computers). That is, the cover glass 8 is for protection of an image display surface, but the use of a glass-made cover member is not limited to as a cover glass for an image display surface: it can also be used, for example, as an exterior cover for digital appliances. The main face s1 is one face as a face that covers an image display surface, and although it is assumed to be a flat face here, it may instead be a curved face.

First, in the dropping process (A), a predetermined amount of molten glass 3 is dropped into a depression 1a in a lower mold 1. That is, molten glass 3 obtained by melting in a furnace is poured out through a platinum nozzle 6 and cut with a blade 5 so that a predetermined amount of molten glass 3 is dropped into the depression 1a in the lower mold 1. To prevent the molten glass 3 from being cooled rapidly by the lower mold 1, the lower mold 1 is heated by a heater 4. Thus, the molten glass 3 in the depression 1a is maintained/controlled to be in a state where a predetermined viscosity is maintained. Here, in the depression 1a in the lower mold 1, in its bottom face, a depression 1b patterned in a predetermined shape is formed.

In the subsequent moving process (B), the lower mold 1 is moved to a predetermined position under an upper mold 2, and an outer mold 9 having a rectangular opening 9h and a recess 9a is placed on the lower mold 1. Like the lower mold 1, the upper mold 2 and the outer mold 9 are heated by a heater 4 to prevent the molten glass 3 from being cooled rapidly. Accordingly, the molten glass 3 in the depression 1a is maintained/controlled to be in a state where a predetermined viscosity is maintained even in contact with the upper mold 2 etc. Also, through temperature control by the heater 4, it is possible to stabilize the clearance between the upper mold 2 and the outer mold 9.

After the lower mold 1 is left to stand for a predetermined period in the moving process (B), the pressing process (C) starts. In the pressing process (C), the upper mold 2 is lowered so that the upper mold 2 passes through the opening 9h in the outer mold 9, and the molten glass 3 in the depression 1a in the lower mold 1 is pressed by the upper mold 2. Through this pressing, the space enclosed by the lower mold 1, the upper mold 2, and the outer mold 9 is filled by the molten glass 3, and thereby a preform 7 is formed which is composed of the molding main body 7a (FIGS. 6D and 6F) corresponding to the cover glass 8 (FIGS. 6E and 6G) and a to-be-worked portion 7b and an excess portion 7c unnecessary for the cover glass 8. Here, the extent of the molten glass 3 is restricted by the inner wall face of the outer mold 9, so that the mold-enclosed space is filled by the molten glass 3. By appropriately setting the dimension of the mold-to-mold clearance, it is possible to exhaust air from the mold-enclosed space easily while holding the molten glass 3 there stably.

The wall thickness of the to-be-worked portion 7b of the preform 7 (i.e., the thickness from the reverse face s2 to the reverse face s3) is set at a predetermined dimension with high freedom. If temperature drops as the molten glass 3 is dropped onto the lower mold 1, moldability diminishes, making it difficult to make the molten glass 3 as thin as a predetermined thickness (i.e., the thickness from the main face s1 to the reverse face s3). To prevent that, in this embodiment, the sheet thickness is set larger than that of the cover glass 8 as the finished product so that, by grinding or polishing the set to-be-worked portion 7b in the working process (D) to (G), the to-be-worked portion 7b can be removed from the preform 7. The larger sheet thickness helps prevent a drop in the temperature of the molten glass, and makes it possible to fill glass in the mold-enclosed space forming the upright wall 8w.

As a result of the filling with the molten glass 3 in the pressing process (C), as shown in FIG. 6D, the inner wall face w1 of an upright wall 7w and the main face s1 are molded by the upper mold 2, the outer wall face w2 of the upright wall 7w and the reverse face s2 of the main face s1 are molded by the lower mold 1, and on the reverse face s2 side of the main face s1, the to-be-worked portion 7b is left. This reverse face s2 on the to-be-worked portion 7b is composed of a plurality of circular depressions T1 and a rectangular elevation T2 formed to protrude relative to them, which are formed by the molten glass 3 filling the depression 1b in the lower mold 1. Of the entire surface of the preform 7, the faces indicated by broken lines (FIG. 6D), i.e., the inner wall face w1 and the outer wall face w2 of the upright wall 7w and the main face s1, are mirror-molded faces transferred from the lower mold 1 and the upper mold 2.

The surface roughness of the reverse face s2 molded by the lower mold 1 tends to be worse than that of the main face s1 molded by the upper mold 2. This results from the former being more influenced by the molten glass 3 being cooled by the lower mold 1 when spreading during pressing. On the other hand, the main face s1, which is a face molded by the upper mold 2, is hardly influenced by the cooling of the glass, and thus becomes a mirror surface. The main face s1 and the inner wall face w1 of the upright wall 7w are difficult to polish into a mirror surface, but since they are faces molded by the upper mold 2, they do not require polishing. As for the reverse face s2, which is a face molded by the lower mold 1, even when molding does not make it a mirror surface, it can be polished into a mirror surface.

In the pressing process (C), the end part shape of the upright wall 7w is restricted by the outer mold 9. With the space enclosed by the lower mold 1, the upper mold 2, and the outer mold 9 filled with the molten glass 3, restricting the end part shape of the upright wall 7w by the outer mold 9 allows the molten glass 3 to spread evenly throughout the mold-enclosed space, and this results in better moldability with the molten glass 3. Moreover, even if an uneven temperature distribution in the molten glass 3 causes an uneven flow of the molten glass 3, the outer mold 9 restricts the flow of the molten glass 3, which thus spreads up to every corner in the mold-enclosed space. This makes the molding of the preform 7 easier.

The molten glass 3 that has risen along the inner wall face of the depression 1a is restricted by the outer mold 9, and meanwhile flows into the recess 9a provided as an excess glass space in the outer mold 9 (FIG. 6C). As a result, as shown in FIG. 6D, an excess portion 7c is formed. In this way, in the pressing process (C), it is preferable to form, with the outer mold 9, an unnecessary excess portion 7c on the cover glass 8 in an end part of the upright wall 7w. This helps improve the flow of the molten glass 3, and in addition helps increase the heat capacity of a circumferential part and thereby make the upright wall 7w less likely to crack, facilitating thin wall molding.

The preform 7 obtained through the pressing process (C) is released from the molds and taken out, and then the working process (D) to (G) starts. As shown in FIGS. 6D and 6F, the preform 7 is composed of the molding main body 7a, the to-be-worked portion 7b (hatched), and the excess portion 7c (hatched). As mentioned above, the reverse face s2 on the to-be-worked portion 7b is composed of the plurality of circular depressions T1 and the rectangular elevation T2 formed to protrude relative to them. In the working process (D) to (G), at least either flat-face grinding or flat-face polishing is performed to completely remove the to-be-worked portion 7b and the excess portion 7c, which are unnecessary parts, from the preform 7 (i.e., by grinding or polishing the to-be-worked portion 7b from the reverse face s2 side of the main face s1, the to-be-worked portion 7b is removed from the preform 7; by grinding or polishing the excess portion 7c from the main face s1 side, the excess portion 7c is removed from the preform 7). This leaves the molding main body 7a alone; that is, as shown in FIGS. 6E and 6G, the cover glass 8 as a finished product is formed. As shown in FIGS. 6E and 6G, the cover glass 8 is composed of the cover main body 8a having the main face s1 and its reverse face s3 and the upright wall 8w formed to extend from the peripheral part of the cover main body 8a.

The flat-face grinding or flat-face polishing on the to-be-worked portion 7b is performed on the reverse face s2, which has been in contact with the bottom face of the depression 1a, and involves first roughly flat-surface-grinding, with a polishing pad or a polishing whetstone, a plurality of preforms 7 together and then finely flat-surface-polishing them with a polishing pad. Switching from flat-face grinding to flat-face polishing is easily achieved by changing the polishing liquid applied to the reverse face s2. In a case where the reverse face s3 of the cover glass 8 need not be made a mirror surface, a coat may be formed on the reverse face s3 to obtain desired smoothness. In a case where the reverse face s3 of the cover glass 8 is made a curved surface, curved-face grinding or curved-face polishing can be performed on the to-be-worked portion 7b.

Through the filling with the molten glass 3 in the pressing process (C), the inner wall face w1 of the upright wall 8w and the main face s1 are molded by the upper mold 2, and thus no bending is necessary. Moreover, the to-be-worked portion 7b removed by grinding or polishing in the working process (D) to (G) is located on the reverse face s2 side of the main face s1 in the pressing process (C), and thus not only the working process (D) to (G) but also molding in the pressing process (C) can be performed satisfactorily and easily. Thus, with the configuration according to this embodiment, it is easy to fabricate a box-shaped cover glass 8 with a small radius of curvature at the boundary between the inner wall face w1 of the upright wall 8w and the main face s1 and with satisfactory exterior appearance quality.

The main face s1 and the inner wall face w1 are both formed by the upper mold 2, and thus the high precision of the upper mold 2 can be reflected on the surface accuracy of the main face s1 and the inner wall face w1 of the cover glass 8. For example, it is possible to perform molding so as to make the boundary face between the main face s1 and the inner wall face w1 a smooth curved surface. Thus, with the configuration according to this embodiment, it is possible to control and in addition improve the accuracy of the main face s1 and the inner wall face w1 of the cover glass 8. This configuration is particularly effective in the molding of high-viscosity glass, which is difficult to control.

The reverse face s3 of the cover glass 8 is formed by performing flat-face grinding or flat-face polishing on the to-be-worked portion 7b from the reverse face s2 side of the preform 7. When, in the working process (D) to (G), the to-be-worked portion 7b is removed from the preform 7 by grinding or polishing, it is preferable to remove the to-be-worked portion 7b with reference to the main face s1. By removing the to-be-worked portion 7b with reference to the main face s1, it is possible to accurately and easily control the thickness of the cover glass 8 (i.e., the thickness from the main face s1 to the reverse face s3).

In the working process (D) to (G), it is preferable to remove the excess portion 7c by grinding or polishing it parallel to the main face s1. By removing the excess portion 7c parallel to the excess portion 7c, it is possible to control the height of the cover glass 8 accurately and easily.

Moreover, in the working process (D) to (G), it is preferable to remove the excess portion 7c with reference to the reverse face S3 (exposed face) of the molding main body 7a after removal of the to-be-worked portion 7b. Since the reverse face S3 is formed with reference to the main face s1, by removing the excess portion 7c with reference to the reverse face S3, it is possible to control the height of the cover glass 8 accurately and easily.

As shown in FIG. 6F, the excess portion 7c of the preform 7 is formed around the entire circumference of the molding main body 7a; instead, it may be formed on part of the molding main body 7a. The cover glass 8 is shaped like a box, but may instead have a U-shaped sectional shape. The inner wall face w1 may comprise a single pair of faces located opposite each other so as to correspond to the rectangular shape of the image display surface.

It is preferable that the thickness d1+d2 (FIG. 6D) of the preform 7 from the main face s1 to its reverse face s2 be three to seven times the thickness d1 of the molding main body 7a from the main face s1 to its reverse face s3. With (d1+d2)/d1 smaller than 3, it is difficult to press and spread molten glass 3. This makes it difficult to perform pressing evenly over the entire surface, and thus results in lower surface accuracy. With (d1+d2)/d1 larger than 7, much of the molten glass 3 is wasted during working. Moreover, the large amount of heat leads to a large amount of shrinkage in the molten glass 3, and this lowers the surface accuracy of the main face s1 as the molded face.

By performing flat-face grinding or flat-face polishing on the reverse face s2 of the main face s1 formed by the upper mold 2, it is possible to obtain a high-accuracy surface shape both on the main face s1 and on the reverse face s2. However, to obtain sufficient accuracy on the main face s1, it is necessary to secure as large a molding thickness as possible, and the larger the molding thickness, the heavier the burden of working by grinding or polishing. Making the reverse face s2 a face having depressions T1 and an elevation T2 as in this embodiment helps alleviate the burden of working by grinding or polishing, and in addition the depressions and elevation provide a dressing effect (an effect of eliminating mesh-clogging in the whetstone). Thus, using a preform 7 with a reverse face s2 having depressions T1 and an elevation T2 (FIGS. 6D and 6F) makes it easy to make the reverse face s2 flat at a predetermined position by flat-face grinding or flat-face polishing, and thus makes it possible to shorten the processing time and reduce the processing cost; it is thus easy to fabricate a cover glass 8 having a high-accuracy surface shape both on the main face s1 and on the reverse face s2.

Providing an elevation T2 at the outermost circumference of the reverse face s2 as in this embodiment helps make a central part relatively thin, reduce the amount of glass shrinkage, alleviate glass solidification in a peripheral part, and also reduce warp in the preform 7, and this makes it easy to improve the transfer accuracy of the main face s1. The effect is particularly notable when the area occupied by the elevation T2 in the reverse face s2 is equal to or larger than one-fourth of the total area there. Depending on the sheet thickness and size of the preform 7, the degree of warp varies; by arranging a plurality of circular depressions T1 (or a single depression as the case may be) for reinforcement as in this embodiment, it is possible to effectively reduce warp in the preform 7.

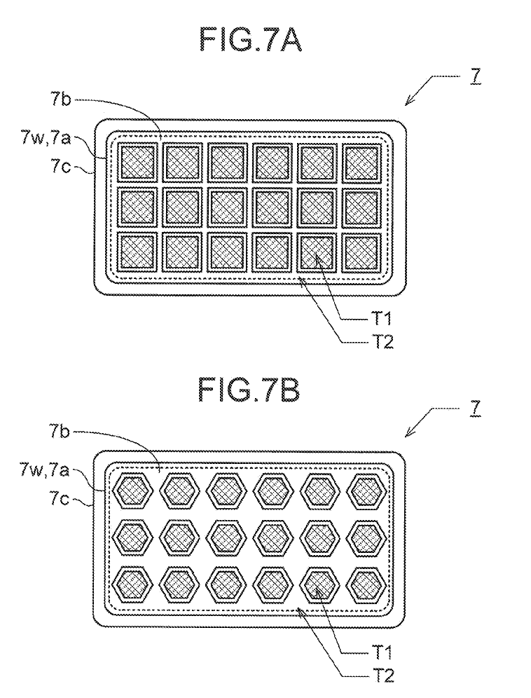

The shape of the depressions T1 is not limited to circular; they may have any other shape easy to mold, such as square, honeycomb-like, or mesh-like. FIGS. 7A and 7B show other practical examples of the preform 7. In the preform 7 shown in FIG. 7A, the depressions T1 in the reverse face s2 has a square shape; in the preform 7 shown in FIG. 7B, the depressions T1 in the reverse face s2 has a honeycomb-like shape. With either shape, the depressions T1 are effective in reducing warp in the preform 7.

By setting the area occupied by the elevation T2 in the reverse face s2 equal to or smaller than one-half of the area of the depressions T1, it is possible to effectively achieve both surface accuracy and ease of processing. By giving the side face of the depressions T1 a tapered shape at an angle of 3° or more relative to the line normal to the bottom face of the depressions T1 (e.g., the cross-hatched parts in FIGS. 7A and 7B), it is possible to easily improve mold releasability.

### Fifth Embodiment

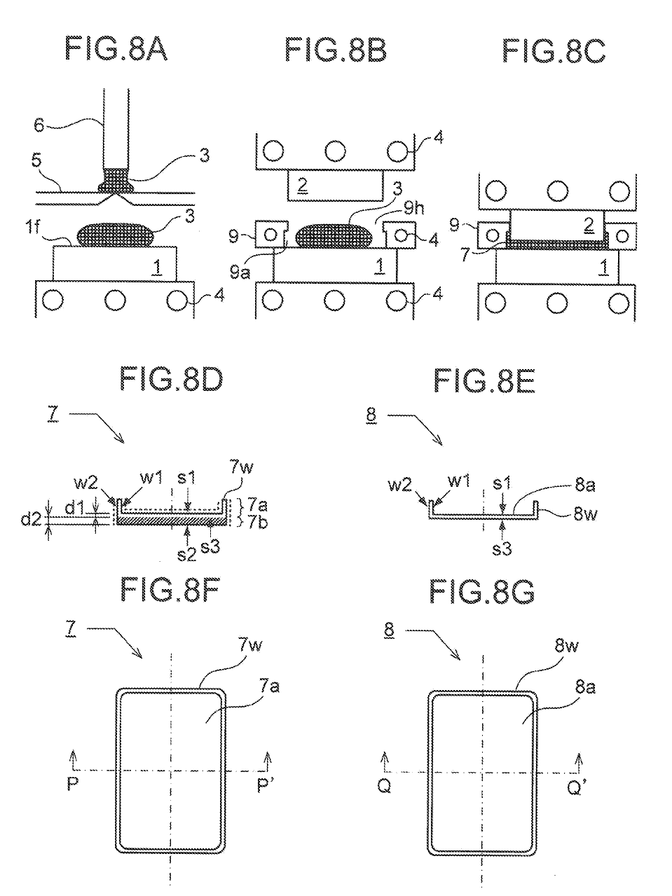

FIGS. 8A to 8G show a method of fabricating a cover glass 8 according to a fifth embodiment of the present invention. This fabrication method includes a molding process shown in sectional views in FIGS. 8A to 8C and a working process shown in sectional views in FIGS. 8D and 8E and in plan views in FIGS. 8F and 8G. Through the molding process, which includes a dropping process (A), a moving process (B), and a pressing process (C), a preform (sheet glass blank) 7 is formed by direct pressing; through the working process (D) to (G), a cover glass 8 as a finished product is formed which is composed of a cover main body 8a having a main face s1 as a molded face and an upright wall 8w formed to extend from a peripheral part of the cover main body 8a. FIG. 8D is a sectional view across line P-P′ in FIG. 8F, and FIG. 8E is a sectional view across line Q-Q′ in FIG. 8G.

The cover glass 8 is, for example, a glass-made cover member used to cover the image display surface of digital appliances having an image display function (e.g., portable electronic appliances such as cellular telephones, smartphones, and mobile computers). That is, the cover glass 8 is for protection of an image display surface, but the use of a glass-made cover member is not limited to as a cover glass for an image display surface: it can also be used, for example, as an exterior cover for digital appliances. The main face s1 is one face as a face that covers an image display surface, and although it is assumed to be a flat face here, it may instead be a curved face.

First, in the dropping process (A), a predetermined amount of molten glass 3 is dropped onto a flat portion 1f of a lower mold 1. That is, molten glass 3 obtained by melting in a furnace is poured out through a platinum nozzle 6 and cut with a blade 5 so that a predetermined amount of molten glass 3 is dropped onto the flat portion 1f of the lower mold 1. To prevent the molten glass 3 from being cooled rapidly by the lower mold 1, the lower mold 1 is heated by a heater 4. Thus, the molten glass 3 on the flat portion 1f is maintained/controlled to be in a state where a predetermined viscosity is maintained.

In the subsequent moving process (B), the lower mold 1 is moved to a predetermined position under an upper mold 2, and an outer mold 9 having a rectangular opening 9h and a recess 9a is placed on the lower mold 1. Here, the outer mold 9 is placed between the upper mold 2 and the lower mold 1 so as to surround the molten glass 3. Like the lower mold 1, the upper mold 2 and the outer mold 9 are heated by a heater 4 to prevent the molten glass 3 from being cooled rapidly. Accordingly, the molten glass 3 on the flat portion 1f is maintained/controlled to be in a state where a predetermined viscosity is maintained even in contact with the upper mold 2 etc. Also, through temperature control by the heater 4, it is possible to stabilize the clearance between the upper mold 2 and the outer mold 9.

After the lower mold 1 is left to stand for a predetermined period in the moving process (B), the pressing process (C) starts. In the pressing process (C), the upper mold 2 is lowered so that the upper mold 2 passes through the opening 9h in the outer mold 9, and the molten glass 3 on the flat portion 1f of the lower mold 1 is pressed by the upper mold 2. Through this pressing, the space enclosed by the lower mold 1, the upper mold 2, and the outer mold 9 is filled by the molten glass 3, and thereby a preform 7 is formed which is composed of the molding main body 7a (FIGS. 8D and 8F) corresponding to the cover glass 8 (FIGS. 8E and 8G) and a to-be-worked portion 7b unnecessary for the cover glass 8. Here, the extent of the molten glass 3 is restricted by the inner wall face of the outer mold 9, so that the mold-enclosed space is filled by the molten glass 3. By appropriately setting the dimension of the mold-to-mold clearance, it is possible to exhaust air from the mold-enclosed space easily while holding the molten glass 3 there stably.

The wall thickness of the to-be-worked portion 7b of the preform 7 (i.e., the thickness from the reverse face s2 to the reverse face s3) is set at a predetermined dimension with high freedom. If temperature drops as the molten glass 3 is dropped onto the lower mold 1, moldability diminishes, making it difficult to make the molten glass 3 as thin as a predetermined thickness (i.e., the thickness from the main face s1 to the reverse face s3). To prevent that, in this embodiment, the sheet thickness is set larger than that of the cover glass 8 as the finished product so that, by grinding or polishing the set to-be-worked portion 7b in the working process (D) to (G), the to-be-worked portion 7b can be removed from the preform 7. The larger sheet thickness helps prevent a drop in the temperature of the molten glass, and makes it possible to fill glass in the mold-enclosed space forming the upright wall 8w.

As a result of the filling with the molten glass 3 in the pressing process (C), as shown in FIG. 8D, the inner wall face w1 of an upright wall 7w and the main face s1 are molded by the upper mold 2, the outer wall face w2 of the upright wall 7w is molded by the outer mold 9, the reverse face s2 of the main face s1 is molded by the lower mold 1, and on the reverse face s2 side of the main face s1, the to-be-worked portion 7b is left. Of the entire surface of the preform 7, the faces indicated by broken lines (FIG. 8D), i.e., the inner wall face w1 and the outer wall face w2 of the upright wall 7w and the main face s1, are mirror-molded faces transferred from the upper mold 2 and the outer mold 9.

The surface roughness of the reverse face s2 molded by the lower mold 1 tends to be worse than that of the main face s1 molded by the upper mold 2. This results from the former being more influenced by the molten glass 3 being cooled by the lower mold 1 when spreading during pressing. On the other hand, the main face s1, which is a face molded by the upper mold 2, is hardly influenced by the cooling of the glass, and thus becomes a mirror surface. The main face s1 and the inner wall face w1 of the upright wall 7w are difficult to polish into a mirror surface, but since they are faces molded by the upper mold 2, they do not require polishing. As for the reverse face s2, which is a face molded by the lower mold 1, even when molding does not make it a mirror surface, it can be polished into a mirror surface.

In the pressing process (C), the end part shape of the upright wall 7w is restricted by the outer mold 9. With the space enclosed by the lower mold 1, the upper mold 2, and the outer mold 9 filled with the molten glass 3, restricting the end part shape of the upright wall 7w by the outer mold 9 allows the molten glass 3 to spread evenly throughout the mold-enclosed space, and this results in better moldability with the molten glass 3. Moreover, even if an uneven temperature distribution in the molten glass 3 causes an uneven flow of the molten glass 3, the outer mold 9 restricts the flow of the molten glass 3, which thus spreads up to every corner in the mold-enclosed space. This makes the molding of the preform 7 easier.

The preform 7 obtained through the pressing process (C) is released from the molds and taken out, and then the working process (D) to (G) starts. As shown in FIGS. 8D and 8F, the preform 7 is composed of the molding main body 7a and the to-be-worked portion 7b (hatched). In the working process (D) to (G), at least either flat-face grinding or flat-face polishing is performed to completely remove the to-be-worked portion 7b, which is an unnecessary part, from the preform 7 (i.e., by grinding or polishing the to-be-worked portion 7b from the reverse face s2 side of the main face s1, the to-be-worked portion 7b is removed from the preform 7). This leaves the molding main body 7a alone; that is, as shown in FIGS. 8E and 8G, the cover glass 8 as a finished product is formed. As shown in FIGS. 8E and 8G, the cover glass 8 is composed of the cover main body 8a having the main face s1 and its reverse face s3 and the upright wall 8w formed to extend from the peripheral part of the cover main body 8a.

The flat-face grinding or flat-face polishing on the to-be-worked portion 7b is performed on the reverse face s2, which has been in contact with the flat portion 1f, and involves first roughly flat-surface-grinding, with a polishing pad, a plurality of preforms 7 together and then finely flat-surface-polishing them. Switching from flat-face grinding to flat-face polishing is easily achieved by changing the polishing liquid applied to the reverse face s2. In a case where the reverse face s3 of the cover glass 8 need not be made a mirror surface, a coat may be formed on the reverse face s3 to obtain desired smoothness. In a case where the reverse face s3 of the cover glass 8 is made a curved surface, curved-face grinding or curved-face polishing can be performed on the to-be-worked portion 7b.

Through the filling with the molten glass 3 in the pressing process (C), the inner wall face w1 of the upright wall 8w and the main face s1 are molded by the upper mold 2, and thus no bending is necessary. Moreover, the to-be-worked portion 7b removed by grinding or polishing in the working process (D) to (G) is located on the reverse face s2 side of the main face s1 in the pressing process (C), and thus not only the working process (D) to (G) but also molding in the pressing process (C) can be performed satisfactorily and easily. Thus, with the configuration according to this embodiment, it is easy to fabricate a box-shaped cover glass 8 with a small radius of curvature at the boundary between the inner wall face w1 of the upright wall 8w and the main face s1 and with satisfactory exterior appearance quality.

The main face s1 and the inner wall face w1 are both formed by the upper mold 2, and thus the high precision of the upper mold 2 can be reflected on the surface accuracy of the main face s1 and the inner wall face w1 of the cover glass 8. For example, it is possible to perform molding so as to make the boundary face between the main face s1 and the inner wall face w1 a smooth curved surface. Thus, with the configuration according to this embodiment, it is possible to control and in addition improve the accuracy of the main face s1 and the inner wall face w1 of the cover glass 8. This configuration is particularly effective in the molding of high-viscosity glass, which is difficult to control.

The reverse face s3 of the cover glass 8 is formed by performing flat-face grinding or flat-face polishing on the to-be-worked portion 7b from the reverse face s2 side of the preform 7. When, in the working process (D) to (G), the to-be-worked portion 7b is removed from the preform 7 by grinding or polishing, it is preferable to remove the to-be-worked portion 7b with reference to the main face s1. By removing the to-be-worked portion 7b with reference to the main face s1, it is possible to accurately and easily control the thickness of the cover glass 8 (i.e., the thickness from the main face s1 to the reverse face s3).

The cover glass 8 is shaped like a box, but may instead have a U-shaped sectional shape. For example, the inner wall face w1 may comprise a single pair of faces located opposite each other so as to correspond to the rectangular shape of the image display surface.

It is preferable that the thickness d1+d2 (FIG. 8D) of the preform 7 from the main face s1 to its reverse face s2 be three to seven times the thickness d1 of the molding main body 7a from the main face s1 to its reverse face s3. With (d1+d2)/d1 smaller than 3, it is difficult to press and spread molten glass 3. This makes it difficult to perform pressing evenly over the entire surface, and thus results in lower surface accuracy. With (d1+d2)/d1 larger than 7, much of the molten glass 3 is wasted during working. Moreover, the large amount of heat leads to a large amount of shrinkage in the molten glass 3, and this lowers the surface accuracy of the main face s1 as the molded face.

In the fifth embodiment (FIGS. 8A to 8G), it is possible to form an excess portion 7c on an end part of the upright wall 7w as in the second embodiment (FIGS. 3A to 3G and FIGS. 4A to 4D); to form an elevation T2 at the outermost circumference of the reverse face s2 of the main face s1 as in the third embodiment (FIGS. 5A to 5G); to form a depression and an elevation (a depression T1 and an elevation T2) on the reverse face s2 of the main face s1 as in the fourth embodiment (FIGS. 6A to 6G and FIGS. 7A,7B); or to adopt more than one of the just-mentioned features in combination.

### LIST OF REFERENCE SIGNS

1 lower mold
1a, 1b depression
1f flat portion
2 upper mold
3 molten glass
4 heater
5 blade
6 platinum nozzle
7 preform
7w upright wall
7a molding main body
7b to-be-worked portion
7c excess portion
8 cover glass (glass component)
8w upright wall
8a cover main body (component main body)
9 outer mold
9a recess
9h opening
T1 depression
T2 elevation
s1 main face
s2 reverse face
s3 reverse face (exposed face)
w1 inner wall face
w2 outer wall face

1. A method for fabricating a glass component including
a component main body having a main face as a molded face and
an upright wall formed to extend from a peripheral part of the component main body,
the method comprising:
dropping a molten glass onto a lower mold;
pressing the molten glass on the lower mold by an upper mold, pressing the molten glass comprising filling a space enclosed by the lower and upper molds with the molten glass to form a preform which includes a molding main body corresponding to the glass component and a to-be-worked portion unnecessary for the glass component; and
removing the to-be-worked portion from the preform by grinding or polishing,
wherein
pressing the molten glass comprises: forming an inner wall face of the upright wall and the main face by the upper mold; forming an outer wall face of the upright wall and a reverse face of the main face by the lower mold; and setting the to-be-worked portion on a reverse face side of the main face, and
in removing the to-be-worked portion, the to-be-worked portion is ground or polished from the reverse face side of the main face.

2. The method according to claim 1, wherein
in removing the to-be-worked portion, the to-be-worked portion is removed with reference to the main face.

3. The method according to claim 1, wherein
pressing the molten glass comprises placing an outer mold which is used to restrict an end part shape of the upright wall and filling a space enclosed by the lower mold, the upper mold, and the outer mold with the molten glass.

4. The method according to claim 3, wherein
pressing the molten glass comprises forming an excess portion unnecessary for the glass component in an end part of the upright wall by the outer mold.

5. The method according to claim 4,
further comprising removing the excess portion by grinding or polishing the excess portion parallel to the main face.

6. The method according to claim 4,
further comprising removing the excess portion with reference to an exposed face of the molding main body after removal of the to-be-worked portion.

7. A method of fabricating a glass component including
a component main body having a main face as a molded face and
an upright wall formed to extend from a peripheral part of the component main body,
the method comprising:
dropping a molten glass onto a lower mold;
pressing the molten glass on the lower mold, pressing the molten glass comprising placing an outer mold, and filling a space enclosed by the lower, upper, and outer molds with the molten glass by pressing the molten glass by the upper mold to form a preform which includes a molding main body corresponding to the glass component and a to-be-worked portion unnecessary for the glass component; and
removing the to-be-worked portion from the preform by grinding or polishing,
wherein
pressing the molten glass comprises: forming an inner wall face of the upright wall and the main face by the upper mold; forming an outer wall face of the upright wall by the outer mold; forming a reverse face of the main face by the lower mold; and setting the to-be-worked portion on a reverse face side of the main face; and
in removing the to-be-worked portion, the to-be-worked portion is ground or polished from the reverse face side of the main face.

8. The method according to claim 7, wherein
a thickness of the preform from the main face to the reverse face thereof is three to seven times a thickness of the molding main body.

9. The method according to claim 7, wherein
pressing the molten glass comprises forming an excess portion unnecessary for the glass component in an end part of the upright wall by the outer mold.

10. The method according to claim 9,
further comprising removing the excess portion by grinding or polishing the excess portion parallel to the main face.

11. The method according to claim 9,
further comprising removing the excess portion with reference to an exposed face of the molding main body after removal of the to-be-worked portion.

12. The method according to claim 7, wherein
pressing the molten glass comprises forming an elevation as part of the to-be-worked portion at an outermost circumference of the reverse face of the main face.

13. The method according to claim 7, wherein
the glass component is a cover glass for covering an image display surface of a portable electronic appliance or an exterior cover of a portable electronic appliance

14. The method according to claim 1, wherein
a thickness of the preform from the main face to the reverse face thereof is three to seven times a thickness of the molding main body.

15. The method according to claim 1, wherein
pressing the molten glass comprises forming an elevation as part of the to-be-worked portion at an outermost circumference of the reverse face of the main face.

16. The method according to claim 1, wherein
the glass component is a cover glass for covering an image display surface of a portable electronic appliance or an exterior cover of a portable electronic appliance
